(19) United States
(12) Patent Application Publication
(10) Pub. No.: US 2025/0296487 A1
(43) Pub. Date: Sep. 25, 2025

(54) RETRACTABLE SEAT COVER SYSTEM

(71) Applicant: TOYOTA BOSHOKU AMERICA, Novi, MI (US)

(72) Inventors: Jeff Moran, Novi, MI (US); Jacob Richter, Novi, MI (US)

(73) Assignee: TOYOTA BOSHOKU AMERICA, Novi, MI (US)

(21) Appl. No.: 19/086,341

(22) Filed: Mar. 21, 2025

Related U.S. Application Data
(60) Provisional application No. 63/567,982, filed on Mar. 21, 2024.

(51) Int. Cl. B60N 2/60

(52) U.S. Cl. CPC B60N 2/6027

(57) ABSTRACT

A retractable vehicle seat cover system including a housing, mounting caps for mounting the housing to a vehicle seat, a retractable cover extendable from the housing, and an anchor clip secured between a seat bottom and a seat back to selectively receive and retain an anchor of the cover to hold the cover against the seat. The cover may be either a “bottom-to-top” version or a “top-to-bottom” version. In the bottom-to-top version, the cover is unrolled from its initial position along the lower edge of the front of the seat base toward the upper edge of the seat back for attachment. In the top-to-bottom version, the cover is unrolled from its initial position along the upper end of the seat back toward the lower edger of the front of the seat base for attachment.

### CROSS REFERENCE TO RELATED APPLICATION

This application is a U.S. Non-provisional Patent Application of U.S. Provisional Patent Application No. 63/567,982 entitled “Retractable Seat Cover System,” filed Mar. 21, 2024, which is herein incorporated by reference in its entirety for all purposes.

### FIELD OF THE INVENTION

The present invention relates to a seat protector, and more particularly to a retractable vehicle seat cover which can be conveniently attached, removed, or stored. The cover may be deployed from bottom-to-top or from top-to-bottom.

### BACKGROUND OF THE INVENTION

Automotive seats are used to transport a wide variety of items including humans, pets, household items, groceries, etc. from one place to another. In doing so, these items inevitably carry a variety of contaminants in solid, liquid and microbiological form which can be transferred from the transported person or item to the surface of the seat. This contamination contributes to a variety of unwanted side effects which include odor, upholstery discoloration, stains, dampness and bacterial contamination. These side effects can lead to decreased car value, increased propensity for colds, and embarrassment for the car owner if significant contamination occurs over time. Because automotive seats can be expensive and make up a highly visible component of the overall vehicle, automobile owners have a vested interest in preserving the natural aesthetic beauty of the original seat. Most owners will tend to avoid covering the surface on a permanent basis due to a preference towards the aesthetic appeal of the original upholstery.

As an example of the need to provide a temporary seat cover, people involved in heavy exercise are frequently faced with the need to enter their car with perspiration-soaked clothing, thus contaminating the surface of the seat with high doses of moisture from sweat which can lead to bacteria build up, odor and even staining of the upholstery over a prolonged period of time. Some people attempt to partially protect the upholstery surface with a clean or used towel which tends to cover only part of the surface, while others simply allow their sweat to be absorbed into the exposed upholstery. Use of a towel can be cumbersome to apply since towels do not carry an anchoring mechanism and may be inconvenient and not practical due to the difficulty in storing a towel in an aesthetically appealing manner within the limited space of an automobile interior.

Also, following visits to the beach, individuals or families frequently find themselves returning to their vehicles with wet clothing and sand filled towels. These vehicle owners must face the challenge of driving and transporting passengers without soaking the seats or soiling them with sand. Many times, there are attempts to use recently used beach towels for protection, however these may be soiled or wet themselves in many cases, causing similar levels of contamination. Frequently, vehicle owners have no alternative but to allow their valuable upholstery to become soaked with moisture and sand.

There are a number of professions which cause a person to arrive at work in clean clothing and return from work with soiled apparel. Mechanics, farmers, professional athletes, construction workers and some blue-collar professions are prone to this. These individuals can carry a wide range of grease, dirt and other contaminants which can leave a visible stain on their vehicle upholstery. Without using a temporary means of protection, the owner will continually leave increased levels of stains to the vehicle.

In hot weather climates, vehicle owners frequently must temporarily leave their vehicles in direct sunlight while accomplishing routine errands. After a prolonged period of time, the interior of the vehicle can become extremely hot to the point of discomfort. One of the hottest surfaces, particularly in dark interior vehicles, is the seat. Prolonged exposure to intense heat can cause damage to upholstery. Even worse, extreme heat levels can cause a passenger to get burned by the heated upholstery, particularly if wearing shorts that expose the skin to direct contact with the scorching fabric. Temporarily covering a dark seat with a light heat deflecting fabric will allow a vehicle owner to remove the protective covering upon return to the vehicle and diminish the heat level that comes in contact with the driver or passenger.

Pet owners who bring their pet along on periodic trips will tend to accumulate pet hair on upholstery over time which will have the propensity to get re-transferred onto a human passenger's clothing in the future. Pet odors also can get trapped within the upholstery causing unwanted odors for passengers.

Families with children also have a need for seat protection given that a child's car seat can cause damage to vehicle seats, a child's snacks or drinks may cause a mess that can stain or damage the vehicle seat, or even a child or adult passenger becoming sick in the vehicle can stain or damage the vehicle seat. For all of these reasons a seat cover that protects the vehicle seat from stains and damage is desired.

Attempts have been made to provide vehicle seat covers; however, existing solutions are not well anchored to the vehicle seat to hold the cover to the seat surface in a fixed position. Accordingly, existing seat covers have a poor aesthetic appearance, looking saggy and poorly fitted and also move, bunch, fold, and wrinkle during ingress, egress, and other dynamic movements of passengers, pets, and/or cargo, making the seat covers effectively useless. Existing solutions also do not offer an effective way to clean or service the cover material when it becomes dirty or damaged.

Thus, there exists a need for retractable vehicle seat cover that is easily stored when not in use, that conforms to the seat and remains in a desired position during use, and that is easily removable for washing, repair, or replacement.

### SUMMARY OF THE INVENTION

The present invention provides a retractable seat cover system that includes a housing, mounting caps for mounting the housing to a vehicle seat, a retractable cover extendable from the housing, and an anchor clip secured between a seat bottom and a seat back to selectively receive and retain an anchor of the cover. The cover being entirely removable from the housing for washing, repair, or replacement. The housing including a base and a lid that are joined together at a hinge, the base and lid defining a cavity within the housing when the housing is in a closed position, the base and lid configured to move relative to one another about the hinge to an opened position of the housing. A first mounting cap and a second mounting cap are configured to be fixed to a vehicle seat. the first mounting cap configured to releasably receive and secure a first end of the housing and the second mounting cap configured to releasably receive and secure a second end of the housing. The cover is configured to be placed in the cavity of the housing. The cover having a first end with a first anchor attached thereto that is configured to be outside of the housing when the housing is in the closed position. A second end of the cover configured to be retained within the housing when the housing is in the closed position. The cover also having a second anchor disposed on the cover at a position between the first end and the second end of the cover. The anchor clip configured to be secured between a seat back and a seat bottom of the vehicle seat and to selectively receive and retain the second anchor of the cover.

There are several advantages of the disclosed inventive system when compared with known technologies. One such advantage is that it is integrated within OEM vehicle systems whereby the seat cover is an embedded feature in the vehicle. The cover can then be deployed when needed and stored when not depending on the needs of the vehicle operator and passengers. The methods and features defined in this invention and set forth in detail hereafter leverage the interface with the vehicle seat utilizing components within the seat (existing headrests, ISOFIX anchors, seatbelts, etc.) while also leveraging detailed knowledge of particular seat specifications (profiles, geometry, etc.) that accompany the requirements of a vehicle seat manufacturer. Ultimately, the disclosed invention is designed to provide convenience to the end-user with systems that are easy to operate and that can be quickly utilized on-demand as opposed to current products that have semi-permanent, complex, and inconvenient installation and operation methodologies.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a retractable seat cover system according to embodiments of the present invention installed on a vehicle seat and in a stored configuration;

FIG. 2 shows a retractable seat cover system according to embodiments of the present invention installed on a vehicle seat and in a deployed configuration;

FIG. 3A shows an assembled retractable seat cover system according to embodiments of the present invention separated from a seat;

FIG. 3B shows the retractable seat cover system of FIG. 3A with the housing separated from the mounting caps;

FIG. 4A is a cross sectional view of a retractable seat cover system according to embodiments of the present invention in which the cover is positioned within the closed housing;

FIG. 4B is a is a cross sectional view of a retractable seat cover system according to embodiments of the present invention in which the cover is positioned within the opened housing;

FIG. 4C is a is a cross sectional view of a retractable seat cover system according to embodiments of the present invention in which the cover is removed from the opened housing;

FIG. 5 is a perspective view of an anchor clip of a retractable seat cover system according to embodiments of the present invention;

FIG. 6 is a cross sectional view of a vehicle seat with an anchor clip installed therein according to embodiments of the present invention;

FIG. 7A is a side view of a vehicle seat with a retractable seat cover system mounted thereto in a stored configuration;

FIG. 7B is a side view of a vehicle seat with a retractable seat cover system mounted thereto in a stored configuration and showing how the cover is deployed;

FIG. 7C is a side view of a vehicle seat with a retractable seat cover system mounted thereto with the cover pulled out from the housing during the process of deploying the cover;

FIG. 7D is a side view of a vehicle seat with a retractable seat cover system mounted thereto with the cover in a deployed configuration covering the seat;

FIG. 8 shows a retractable seat cover system according to an additional embodiment of the present invention installed on a vehicle seat and in a stored configuration;

FIG. 9 shows a retractable seat cover system according to the embodiment of FIG. 8 showing the seat cover in a deployed configuration;

FIG. 10A is a cross sectional view of a vehicle seat with the retractable seat cover system of FIG. 8 mounted thereto in a stored configuration;

FIG. 10B is a cross sectional view of a vehicle seat with a retractable seat cover system mounted thereto in a stored configuration and showing how the cover is deployed;

FIG. 10C is a side view of a vehicle seat with a retractable seat cover system mounted thereto with the cover in a deployed configuration covering the seat;

FIG. 11 shows a front view of a vehicle seat system illustrating the seat cover in its deployed condition;

FIG. 12 shows a top view looking down illustrating the seat of FIG. 11;

FIG. 13 illustrates an ISOFIX anchor for incorporation into a vehicle seat;

FIG. 14 shows an exemplary version of a press-fit clipping attachment for use in the present system;

FIG. 15 is a side view of an embodiment of the press-fit clipping component being attached to an ISOFIX anchor;

FIG. 16 shows a front (outer) view of the press-fit clipping component of FIG. 15;

FIG. 17 is a side view of an alternative embodiment of the press-fit clipping component being attached to an ISOFIX anchor;

FIG. 18 is a side view of an additional embodiment of the press-fit clipping component being attached to an ISOFIX anchor;

FIG. 19 is a side view of a magnetic embodiment of the attachment component being attached to an ISOFIX anchor;

FIG. 20 shows a front (outer) view of the magnetic embodiment of the attachment component of FIG. 19;

FIG. 21 shows a perspective view of a partially unrolled cover having a movable and adjustable fastener arrangement;

FIG. 22A shows an end view of the partially unrolled cover of FIG. 21 and illustrating the adjustable fastener arrangement moved to its initial position.

FIG. 22B is similar to the view of FIG. 22A but illustrating the adjustable fastener arrangement moved to a different position;

FIG. 23A shows a front view of a clipping arrangement in which the clips are moved to first positions;

FIG. 23B shows a view similar to that of FIG. 23A but illustrating the clips moved to their second positions;

FIG. 24 shows an underside view of a portion of the partially unrolled cover with the clips in position for attachment to the ISOFIX anchors;

FIG. 25 shows a front view of an extended bottom-to-top cover according to a first embodiment; and

FIG. 26 shows a front view of an extended bottom-to-top cover according to a second embodiment.

### DESCRIPTION OF THE INVENTION

The present invention has utility as a vehicle seat cover that is easily stored when not in use, that conforms to the seat and remains in a desired position during use, and that is easily removable for washing, repair, or replacement.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

The terminology used herein is for the purpose of describing particular example embodiments only and is not intended to be limiting. Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. Unless indicated otherwise, explicitly or by context, the following terms are used herein as set forth below.

As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present invention is illustrated in essentially two versions, a “bottom-to-top” version and a “top-to-bottom” version. Both references indicate the direction of travel of the cover when moved from its stored position to its deployed position. Accordingly, in general, the bottom-to-top version describes an embodiment of the present invention which is unrolled from its initial position along the lower edge of the front of the seat base toward the upper edge of the seat back for attachment while the top-to-bottom version is unrolled from its initial position along the upper end of the seat back toward the lower edger of the front of the seat base for attachment.

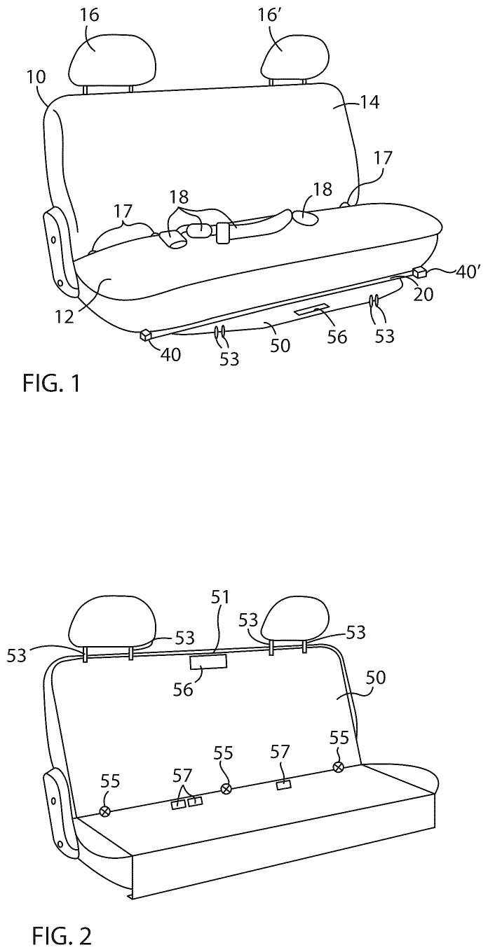

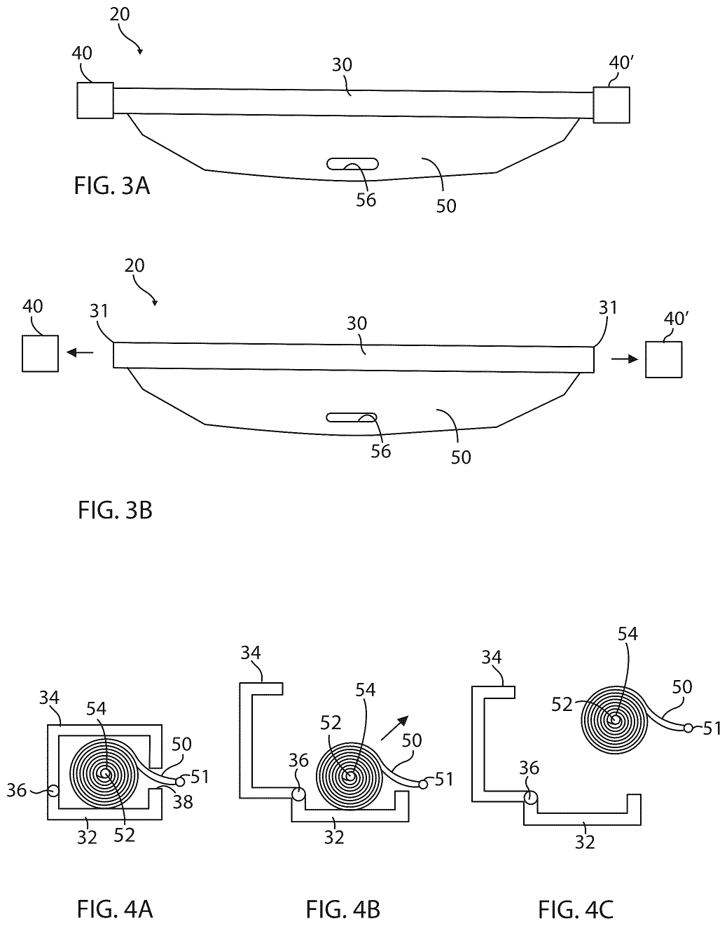

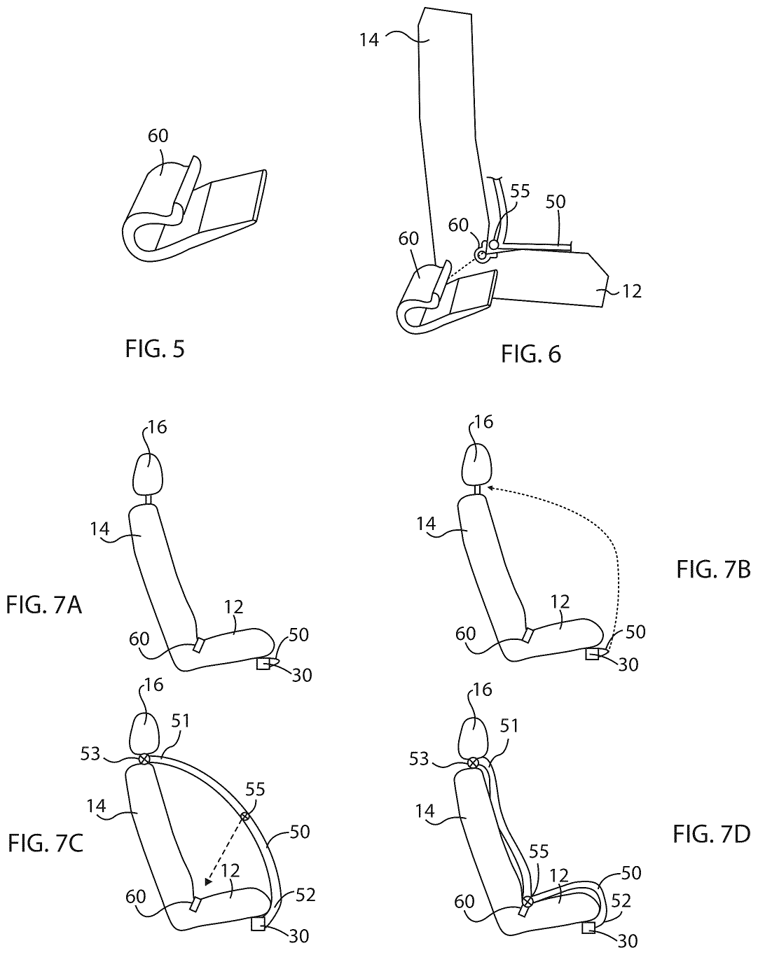

FIG. 1 shows a bench seat 10 of a vehicle with a bottom-to-top retractable seat cover system 20 installed and in a stored configuration. It will be understood that the inventive seat cover system is suitable for use on any vehicle seat including driver seats, passenger seats, front seats, back seats, bench seats, captain seats, third row seats, etc. It will also be understood that the inventive seat cover system is suitable for use not only on personal vehicles but also on public transit vehicles, including buses, airplanes, subways, trains, taxi cabs, etc. The arrangement shown in FIG. 1 is a rear bench seat 10 with three adjacent seats. The seat 10 includes a typical seat base 12, a seat back 14, and head rests 16, 16′. The seat 10 also includes seat belts 18 and related locking fixtures. Rear seats such as seat 10 also include ISOFIX anchors 17 for child safety seats.

According to embodiments, a retractable seat cover system 20 includes a housing 30 that is mounted transversely across the front of the seat frame below the seat bottom cushion 18. The housing 30 includes a base 32 and a lid 34. According to embodiments, the base 32 and the lid 34 each have a C-shaped cross section. The base 32 and the lid 34 are joined together at a hinge 36. According to embodiments, the hinge extends along the entire length of the housing 30. Alternatively, the hinge 36 may include a plurality of discrete hinges 36 spaced apart along the length of the housing 30. The base 32 and the lid 34 together define a cavity within the housing 30 when the housing 30 is in a closed position, as shown in FIG. 4A. Notably, even when the housing 30 is in the closed position, an opening 38 is provided in the housing 30 through which the cover 50 can be passed. The base 32 and the lid 34 are configured to move relative to one another about the hinge 36 to put the housing 30 in an opened position, as shown in FIGS. 4B and 4C. According to embodiments, the housing 30 is made of metal, plastic, or a composite material.

The housing 30 is mounted to the vehicle seat 10 by at least two mounting caps 40. According to embodiments, the mounting caps 40 are fixed to a frame of the vehicle seat 10. According to embodiments, the mounting caps 40 are fixed to the vehicle seat 10 under the seat base 12. As shown in FIG. 1, a first mounting cap 40 is mounted at a first side of the vehicle seat 10 while a second mounting cap 40′ is mounted at the opposite side of the vehicle seat such that the housing 30 may extend along the entire width of the vehicle seat 10. The mounting caps 40 are configured to releasably receive and secure the ends 31 of the housing 30. According to embodiments, the mounting caps 40 are configured to hold the housing 30 in the closed position when the housing 30 is installed in the mounting caps 40. According to embodiments, at least one of the mounting caps 40 includes a spring rolling mechanism therein that is configured to retract the cover 50 into the housing.

According to embodiments, the cover 50 is a flexible material that may be rolled and unrolled repeatedly. The material contours to the shape of the vehicle seat 10. Also, it is preferable that the material be highly opaque to ultraviolet light. The cover 50 includes a length of material having a first end 51 and a second end 52. The cover 50 is configured to be rolled up and placed in the cavity of the housing 30 when the housing 30 is in the opened position. Upon moving the housing 30 to the closed position, the cover 50 is then retractably retained within the housing 30. The cover 50 is mounted within the housing 30 in a manner similar to a window shade. The cover 50 is accordingly retractability extendable from the housing 30 and biased to automatically be retracted into the housing 30 when first end 51 of the cover 50 is not secured to the vehicle seat 10.

The first end 51 of the cover 50 has a first anchor 53 attached thereto. According to embodiments, the first anchor 53 is configured to remain outside of the housing 30 even when the housing is in a closed position so that the cover 50 may be pulled from the housing 50 to cover the seat 10. The second end 52 of the cover 50 is intended to be retained within the housing 30 when the housing is in a closed position and the first end 51 of the cover 50 is pulled to remove the cover 50 from the housing 30 in order to cover the seat 10. According to embodiments, the second end 52 has an anchor 54 attached thereto that is configured to retain the second end of the cover within housing when the housing is in the closed position. According to embodiments, the anchor 54 at the second end 52 of the cover 50 is a pocket formed in the material of the cover 50 that is configured to receive a rod within the pocket. The rod being larger than the opening in the housing 30 when the housing is in the closed position accordingly retains the second end 52 of the cover within the housing 30 when the housing is closed, while still allowing for easy disassembly so the cover 50 can easily be removed and washed. The first anchor 53 at the first end 51 of the cover 50 is configured to selectively secure the first end 51 of the cover 50 a top of a seat back 14 of the vehicle seat 10 or to a headrest 16 of the vehicle seat 10. According to embodiments, the first anchor 53 is a hook or a clip or is a pocket sewn into the cover 50 that is configured to be fitted over a seat back 14 of the vehicle seat 10, like a fitted sheet. The cover 50 additionally includes an anchor 55 disposed on the cover 50 at a position between the first end 51 and the second end 52. This anchor 55 is configured to secure the cover 50 to the vehicle seat near where the seat back and seat bottom intersect. According to embodiments, this anchor 55 is piping sewn into the cover 50. According to embodiments, the piping is plastic material. As will be described below, this anchor 55 is configured to be snapped into an anchor clip 60 of the system 20. According to embodiments, the cover 50 additionally includes a handle 56 attached to the first end 51 of the cover 50 for pulling the cover 50 from the housing 30. According to embodiments, the material of the cover 50 is durable and scratch resistant. According to embodiments the cover is treated with a stain resistant coating. According to embodiments, the cover is configured to be entirely removed from the housing 30. According to embodiments, the cover 50 is machine washable. According to embodiments, the cover 50 includes a plurality of cutouts 57 near the anchor 55 between the first end 51 and second end 52 of the cover 50. The cutouts 57 are configured to allow vehicle seat hardware, such as seatbelts and associated fastening locks and child safety seat securements, to be accessible therethrough.

As noted above, the anchor 55 between the first end 51 and second end 52 of the cover 50 is configured to be snapped into an anchor clip 60 of the system 20. As shown in FIG. 6, the anchor clip 60 is configured to be secured between the seat base 12 and seat back 14 of the vehicle seat 10. The anchor clip 60 is configured to selectively receive and retain the anchor 55 that is positioned between the first end 51 and second end 52 of the cover 50 in order to hold the cover 50 securely against the seat base 12 and seat back 14 and resist movement of the cover during ingress and egress or caused by other movements of vehicle passengers or cargo. According to embodiments, the anchor clip 60 is formed of a plastic material. According to embodiments, the anchor clip 60 has a U-shaped cross section into which the piping of the anchor 55 is snapped and retained when it is desired to cover the vehicle seat 10 with the cover 50. According to embodiments, the anchor clip 60 is embedded in the vehicle seat 10 between the seat base 12 and the seat back 14.

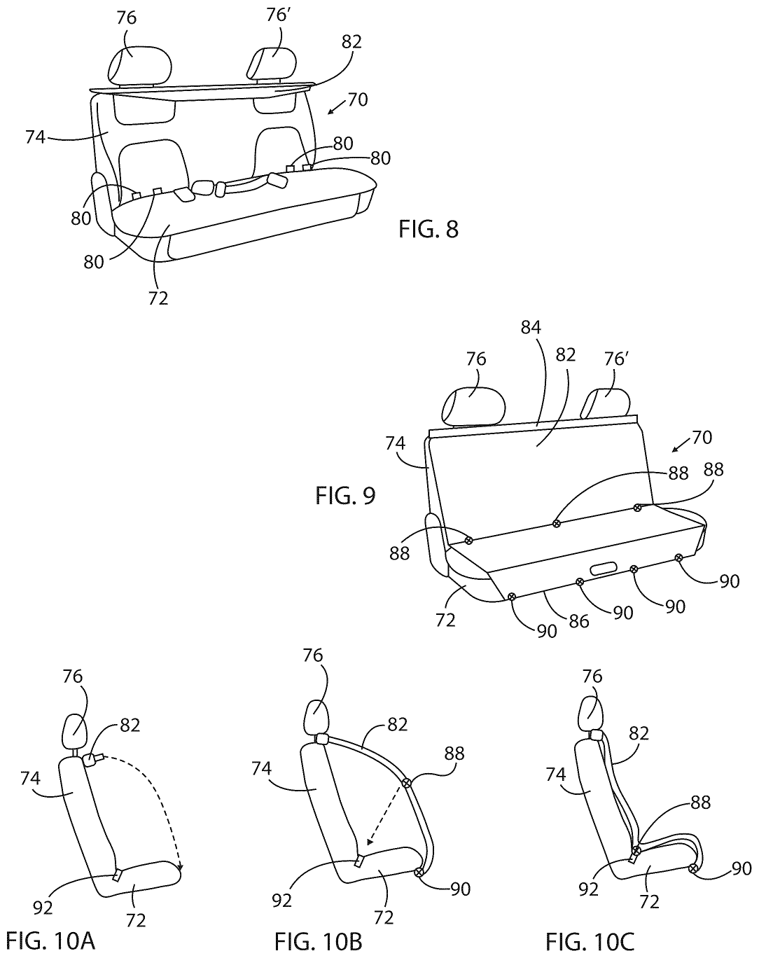

FIG. 8 shows a retractable seat cover system according to an additional embodiment of the present invention in its pre-deployed position while FIG. 9 illustrates the retractable seat cover system in its deployed position. Referring to both FIGS. 8 and 9, a bench seat 70 of a vehicle with a top-to-bottom retractable seat cover system 72 installed and in a stored configuration. It will be understood that the inventive seat cover system is suitable for use on any vehicle seat including driver seats, passenger seats, front seats, back seats, bench seats, captain seats, third row seats, etc. It will also be understood that the inventive seat cover system is suitable for use not only on personal vehicles but also on public transit vehicles, including buses, airplanes, subways, trains, taxi cabs, etc.

The bench seat 70 of FIG. 8 may be any vehicle seat such as the illustrated rear bench seat. However, it is to be understood that the present invention may be adapted for use for use in alternative seat arrangements, such as with a bucket seat (not shown). The seat 70 includes a typical seat base 72, a seat back 74, and head rests 76, 76′. The seat 70 also conventionally includes seat belts 78 and related locking fixtures. Rear seats such as seat 70 also include ISOFIX anchors 80 for child safety seats.

According to the retractable seat cover system illustrated in FIGS. 8 and 9, a top-to-bottom seat cover 82 is illustrated and is attached to the upper end of the seat back 74. Accordingly, the variation of the present invention illustrated in FIGS. 8 and 9 is generally the same as the bottom-to-top seat cover system 20. However, the seat cover 82 mounts at the upper end of the seat back 74 and preferably though not absolutely is removably attached to the head rests 76, 76′. The overall operation concept is the same as original but in the variation of FIGS. 8 and 9 the cover 82 is withdrawn from the top of the seat back 74 and is secured at the lower front edge underneath the cushion of the seat base 72. The methods of securement generally remain the same as that of the embodiment illustrated in FIGS. 1 and 2 and discussed in relation thereto.

The cover 82 includes a first or upper end 84 and a second or lower end 86. The cover has fitted thereto a series of biteline anchors 88 disposed on the cover 82 at positions between the first end 84 and the second end 86. The anchors 88 are configured to secure the cover 82 to the vehicle seat near where the seat back 74 and seat base 72 intersect. According to embodiments, the anchors 88 are piping sewn into the cover 82. According to other embodiments, the piping may be a polymerized material. Attachment points 90 are provided along the lower edge of the seat base 72 for attachment of the second or lower end 86 of the cover 82. The attachment points 90 are selected from the group consisting of hooks, buttons, clipping fasteners, snap fasteners, hook-and-loop (Velcro®), and zippers.

Referring to FIGS. 10A-10C, side views of the seat cover system are illustrated showing the cover 82 in various stages of deployment. With respect to FIG. 10A, the cover 82 is illustrated in its pre-deployed stowed position at the top of the seat back 74. In FIG. 10B, the cover 82 has been moved to the deployed position with the lower end 86 being attached to the attachment points 90 of the seat base 72. Thereafter, and as shown in FIG. 10C, the anchors 88 are attached to anchor clips 92 attached at the intersection of the seat base 72 and the seat back 74.

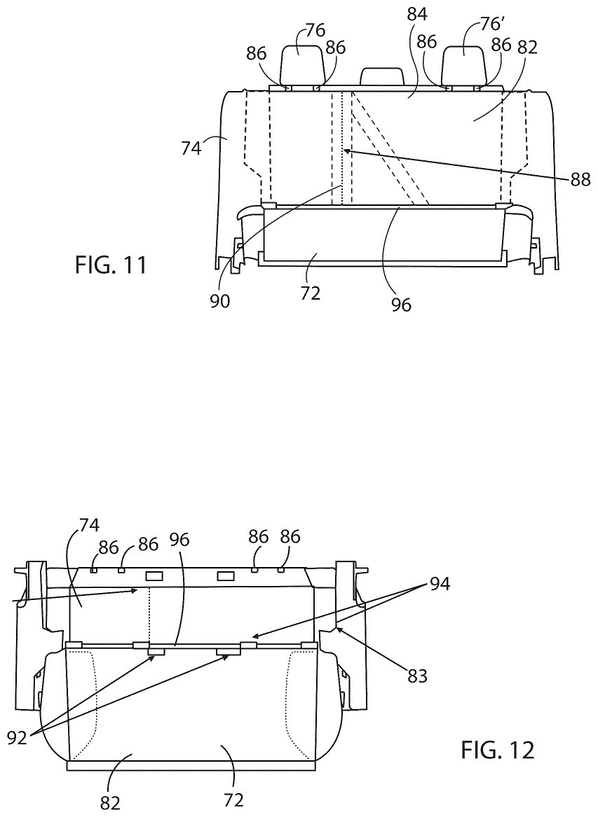

As illustrated in the various figures, the profile of the cover 82 provides protection for the outer surfaces of the seat base 72 and the seat back 74 to achieve 100% protective coverage of interfacing surfaces. This coverage optionally but preferably includes folding bolster flaps 83 for the back and that would deploy from a “stored position” to a “use position.” The complete coverage is illustrated in FIGS. 11 and 12 which respectively illustrate a front view of the seat cover system of the present invention and a top view looking down over the seat assembly. In both figures the seat cover 82 is in its fully deployed condition.

As shown in FIGS. 11 and 12, the upper end 84 of the seat cover 82 is fixed to head rest anchors 86. A pass through 88 is formed in the seat cover 82 to allow passage of a shoulder belt 90 as may be necessary to allow passage through the center seat. Similar pass throughs 92 are formed in the seat cover 82 for seatbelt buckles (not shown) and for ISOFIX latch locations 94. A biteline anchoring system in the form of an anchoring rod 96 is provided for attachment to clips as will be discussed below. The anchoring rod 96 may be movable along the length of the seat cover 82 for attachment to the clips. The anchoring at the biteline may utilize the ISOFIX locations at either two outboard locations or four locations across the seat width depending on securement strength needed.

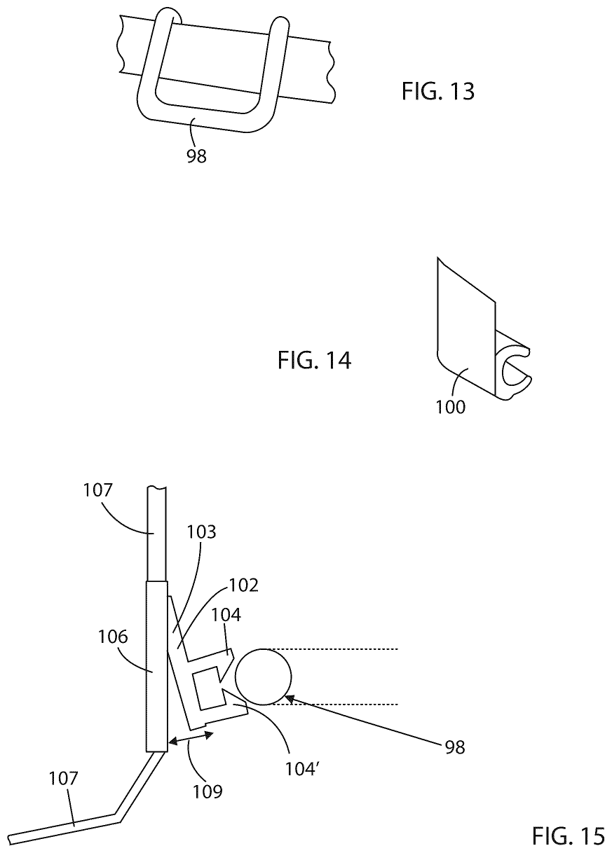

FIG. 13 illustrates a conventional ISOFIX anchor 98 for incorporation into a vehicle seat as is known in the art. The shape of the ISOFAX anchor 98 as illustrated is suggestive and is not intended as being limiting.

Several iterations of biteline anchoring concepts utilizing different securement methodologies to secure the cover 82 to the ISOFIX anchor 98 at the biteline of the seat are provided according to the disclosed invention. Due to the location of the ISOFIX anchor 98 some degree of articulation or insertion between the seat back 74 and the seat base 72 may be needed to obtain the correct depth for securement. Accordingly, hooking, clipping, and magnetic fastening interfaces are all proposed as various methods of attachment. Additionally, an anchoring guide system is provided which utilizes the anchoring rod 96 that links all anchoring locations along the length (fore-aft) of the cover 82 and allows adjustment along the axis. The guide also allows the anchoring components be manipulated laterally (side-side) to align them to the ISO-Fix locations. Any of the fastening arrangements set forth below could be used with this guide system. The disclosed retractable seat cover arrangement of the present invention provides unique value as it provides a common system adaptable to multiple vehicle types as it offers four degrees of freedom to enable anchoring into a correct position.

To attach the anchoring rod 96 to the seat, a press-fit clipping attachment is provided. An exemplary clipping attachment 100 is illustrated in perspective view in FIG. 14. The clipping attachment may be made from any one of several materials but is preferably formed form a polymerized material which provides both durability and some degree of flexibility to allow for attachment to a fixed seat structure such as an ISOFIX

anchor 98. An example of the clipping attachment in operation according to the present invention is illustrate in FIG. 15 which is a side view of an embodiment of the press-fit clipping component being attached to an ISOFIX anchor 98. A one-piece molded clipping arrangement 102 includes a clipping component 103 and spaced apart and opposed jaws 104, 104′ and a base 106. Due to the designed-in flexibility of the clipping arrangement 102, articulating motion 109 is provided for by the arrangement of the clipping component arm 103 relative to the base 106. The clipping arrangement 102 is releasably attached to the ISOFIX anchor 98 by press-fitting the clipping arrangement 102 to the ISOFIX anchor until the ISOFIX anchor 98 is captured between the opposed jaws 104, 104′. Release of the clipping arrangement 102 from the opposed jaws 104, 104′ is achieved by pulling.

A front (outer) view of the clipping arrangement 102. As shown, the clipping arrangement 102 is sewn or heat staked into a portion of a seat cover 107. A partially open space 108 is formed for visibility and operation. A biteline axis B identifies the approximate location of the biteline of the seat cover 82 relative to the clipping arrangement 102.

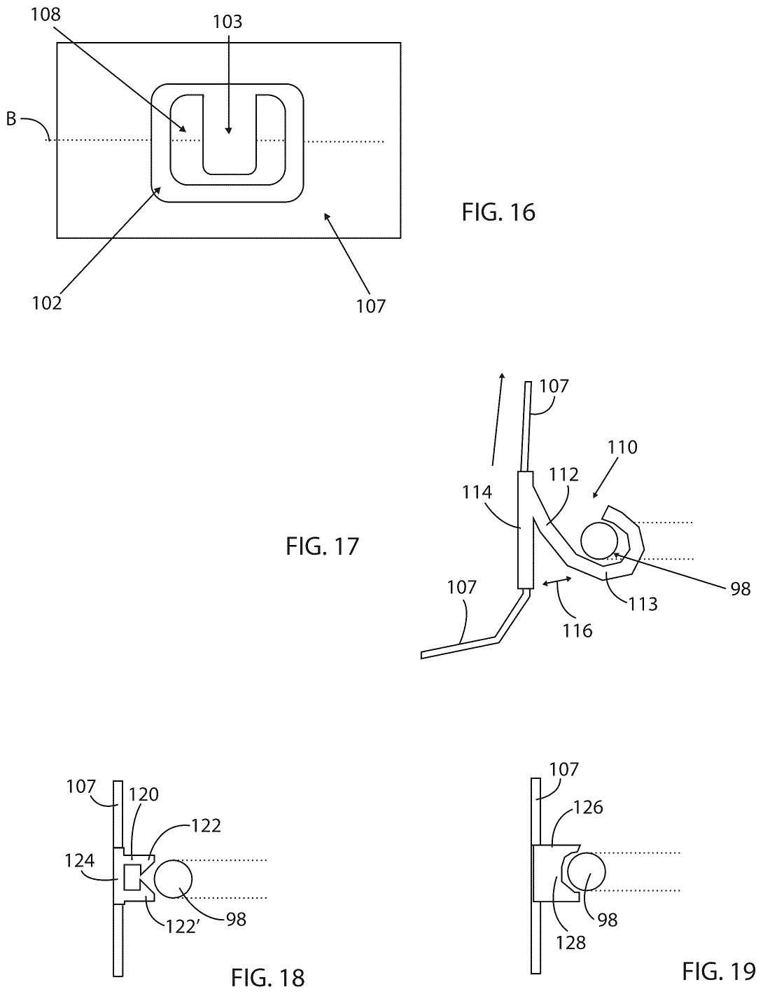

Alternative arrangements for attachment of the cover 82 to an anchor point are envisioned beyond the arrangement of FIGS. 15 and 16. One example of such an alternative press-fit clipping arrangement is illustrated in FIG. 17 which is a side view of a clipping arrangement 110 which may be formed from any of several materials but is preferably formed from a polymerized material. The clipping arrangement 110 may be sewn or heat staked into the cover 82. The clipping arrangement 110 includes a clipping component arm 112 having a hook 113 for releasably receiving the ISOFIX anchor 98. The clipping component arm 112 extends from a base 114. Due to the designed-in flexibility of the clipping arrangement 110, articulating motion 116 is provided for by the arrangement of the clipping component arm 112 relative to the base 114. The clipping arrangement 110 is releasably attached to the ISOFIX anchor 98 by hooking the ISOFIX anchor 98 onto the hook 113. Tension of the cover 82 keeps the hook 113 engaged with the ISOFIX anchor 98. Release of the clipping arrangement 110 from the hook 113 is possible by moving the hook 113 away from the ISOFIX anchor 98.

A further alternative example of the clipping attachment according to the present invention is illustrate in FIG. 18 which is a side view of an embodiment of the press-fit clipping component being attached to an ISOFIX anchor 98. A one-piece molded clipping arrangement 120 is sewn or heat staked to the cover 82. The clipping arrangement 120 includes opposed jaws 122, 122′ and a base 124. The clipping arrangement 120 is releasably attached to the ISOFIX anchor 98 by press-fitting the clipping arrangement 120 to the ISOFIX anchor until the ISOFIX anchor 98 is captured between the opposed jaws 122, 122′. Release of the clipping arrangement 120 from the opposed jaws 122, 122′ is achieved by pulling.

Attachment of the cover 82 to the ISOFIX anchor 98 may also be achieved by the use of magnets. Such an alternative strategy is illustrated in FIG. 19 which illustrates a side view of a magnetic clip assembly 126 which includes a base 126 and a magnet portion 128. The magnetic portion 128 comprises either a magnet formed within the base 126 or may be a magnet attached to the base 126. The magnetic clip assembly 126 allows for easy attachment to or removal from the metal ISOFIX anchor 98.

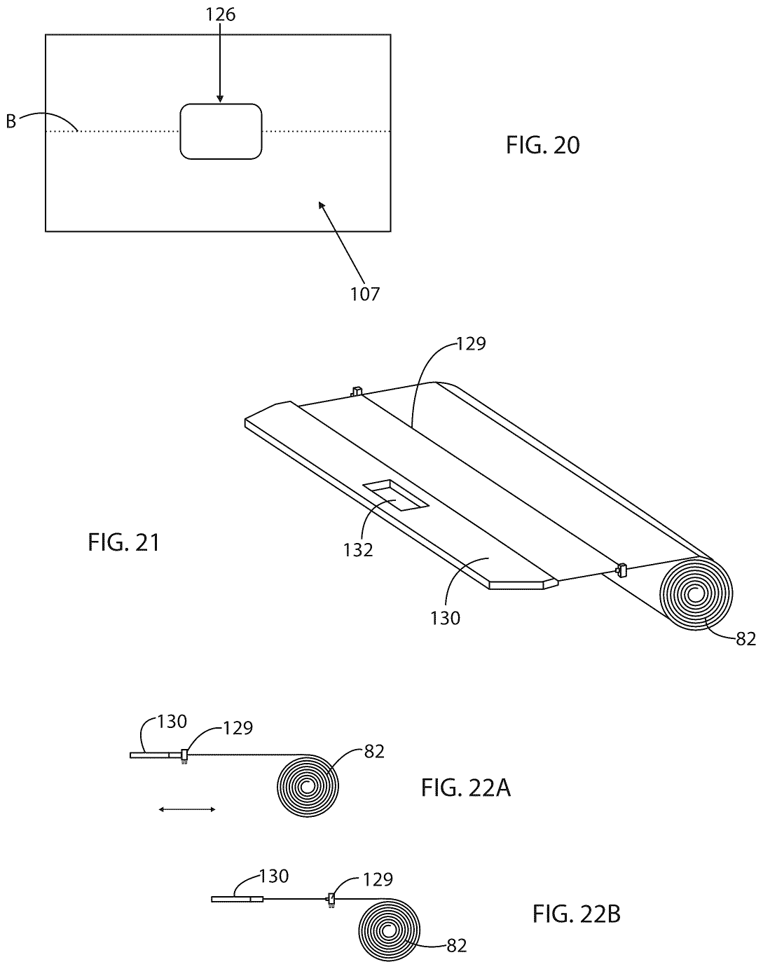

The magnetic clip assembly 126 is attached to the cover material 107 by sewing or heat staking as illustrate in FIG. 20. (The clipping arrangement 120 may be similarly attached.) A biteline axis B identifies the approximate location of the biteline of the seat cover 82 relative to the clipping arrangement 126 (or the clipping arrangement 120).

A separate attachment sleeve component fitted over the cover 82 that can slide along the roll axis when the cover is deployed is provided. Adjustability of the sleeve component is necessitated due to various locations of the ISOFIX anchor 98. Accordingly, some degree of articulation or insertion between the back and cushion of the seat is most likely needed to get the requisite depth for securement. The sleeve component of the present invention allows for such variations. When the cover 82 is retracted the attachment sleeve component nests at the tongue so that it does not interfere with the rolling action of the cover. This arrangement is illustrated in FIGS. 21 through 24.

With reference to FIG. 21, a perspective view of a partially deployed cover having an attachment sleeve component 129 is illustrated in one position on the deployed portion of the cover 82. The attachment sleeve component 129 includes a rigid leading edge 130 which preferably has a handle 132 formed therein. As illustrated in FIG. 22A, the attachment sleeve component 129 may be moved to its stored position adjacent the rigid leading edge 130 for easy storage. As illustrated in FIG. 22B, the attachment sleeve component 129 may be moved to a second position for attachment to any of the above-discussed clipping arrangements. Movement of the attachment sleeve component 129 to any location along the cover 82 is readily achieved and makes the present invention easily adapted to any position for fixing to the seat.

The attachment sleeve component 129 according to the disclosed invention not only provides adjustability of the anchoring or clipping locations along the length (fore-aft) of the cover 82 thereby allowing them to be maneuvered as needed along the axis, but also allows for the anchoring or clipping components be manipulated laterally (side-side) for alignment with the locations of the ISOFIX anchors 98. Any of the clipping arrangements discussed and illustrated herein could be used with the attachment sleeve component 129. This concept has unique value as it could be a common system for multiple vehicle types as it offers four degrees of freedom to get anchoring into correct position.

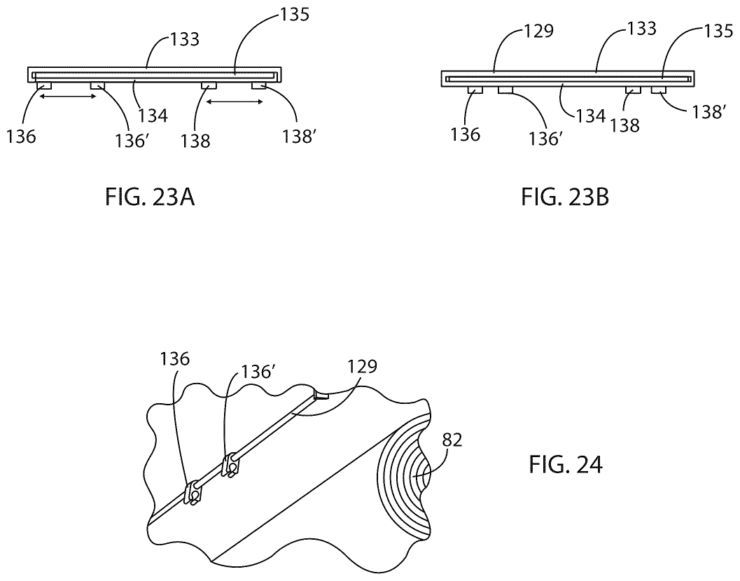

The adaptability of the attachment sleeve component 129 is illustrated in FIGS. 23A and 23B. Referring to FIG. 23A, the attached sleeve component 129 includes an upper portion 133 and a lower portion 134 spaced apart from the upper portion 133. A cover-passing slot 135 is formed between the upper portion 133 and the lower portion 134. FIGS. 23A and 23B also show a front view of the attachment sleeve component 129 which illustrates a first pair of adjacent clipping attachments 136, 136′ in their initial positions and a second pair of clipping attachments 138, 138′ also in their initial positions. As shown in FIG. 23B, the first pair of adjacent clipping attachments 136, 136′ have been moved to their alternative positions and the second pair of clipping attachments 138, 138′ have also been moved to their alternative positions. The first pair of adjacent clipping attachments 136, 136′ are illustrated in perspective view in FIG. 24. It is to be understood that the positions of the clipping attachments as shown in FIGS. 23A, 23B, and 24 are for illustration purposes as it is to be understood that the clipping attachments may be moved to any position along the attachment sleeve component 129.

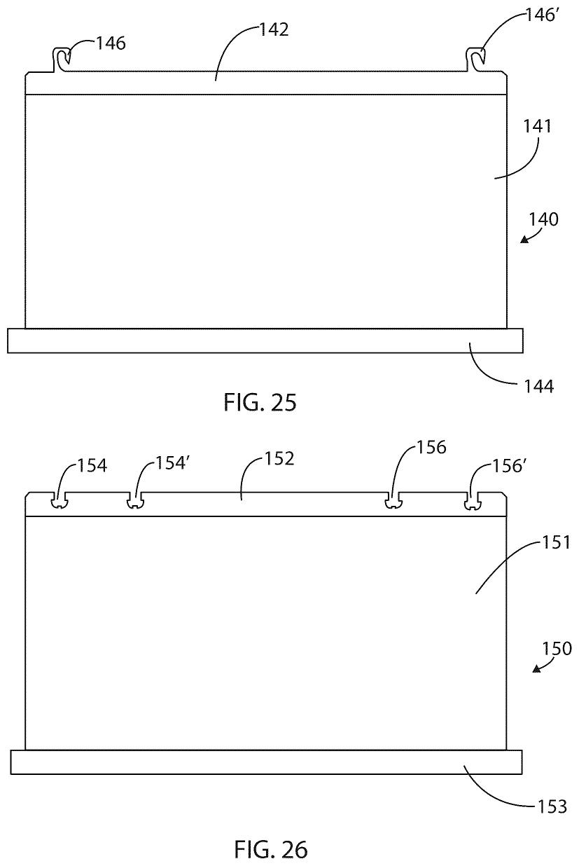

If a bottom-to-top installation strategy is used, anchoring at the headrest is needed. Alternative approaches to anchoring are illustrated in FIGS. 25 and 26 which allow for the anchoring of the leading edge of the cover 82 to be anchored to existing headrest posts or stays. These fastening methods are generally sized to ensure robust connection to the stay or post but also significantly provide the convenience of allowing the user to quickly release or unhook the cover 82 so that it may be retracted back into its stored position.

Referring to FIG. 25, a front view of an extended bottom-to-top cover assembly 140 is illustrated. The cover assembly 140 includes a cover 141 having a leading edge 142 and a trailing or base edge 144. The base edge 144 may be a housing for a retracted cover 141. The leading edge 142 includes a pair of headrest post hooks 146, 146′ which may be easily attached to the existing headrest posts or stays. Removal of the headrest post hooks 146, 146′ is also easily accomplished.

Referring to FIG. 26, a front view of an alternate arrangement of an extended bottom-to-top cover assembly is illustrated and is generally shown as 150. The cover assembly 150 includes cover 151 having a leading edge 152 and a trailing or base edge 153. The base edge 153 may be a housing for a retracted cover 151. The leading edge 152 includes a first pair of U-shaped headrest snap fasteners 154, 154′ for releasable attachment to the posts of a first headrest (not shown) and a second pair of U-shape snap fasteners 156, 156′ for releasable attachment to the posts of a second headrest (not shown). Attachment of the cover assembly 150 to the headrests is readily achieved. Removal of the cover assembly 150 from the headrests is also readily achieved.

The hooks 146, 146′ may also be used for hooking to a post or similar feature provided along the lower edge of the seat base 12 if the cover assembly 140 is utilized in a top-to-bottom configuration in which the base edge 144 is attached to the upper end of the seat back 74. Similarly, the U-shaped fasteners 154, 154′, 156, and 156′ may also be used for attachment to a post or similar feature provided along the lower edge of the seat base 12 if the cover assembly 150 is utilized in a top-to-bottom configuration in which the base edge 153 is attached to the upper end of the seat back 74.

Patent documents and publications mentioned in the specification are indicative of the levels of those skilled in the art to which the invention pertains. These documents and publications are incorporated herein by reference to the same extent as if each individual document or publication is specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A retractable seat cover system for attachment to fixed anchors on a seat, the seat including headrest posts, the retractable cover system comprising:
a seat cover movable from a rolled initial position to a deployed position, the seat cover having a having a leading edge, a base edge, a first side edge and a second side edge opposite the first side edge;
an elongated attachment sleeve component slidably attached to the seat cover, the sleeve component having an upper portion, a lower portion, and a cover-passing slot formed between the upper portion and the lower portion, the sleeve component being movable between the leading edge and the base edge of the cover; and
a plurality of anchor clipping attachments movably fitted to the elongated attachment sleeve component.

2. The retractable seat cover system of claim 1, wherein the elongated attachment sleeve component includes a first end and a second and wherein the anchor clipping attachments are movable between the first and second ends.

3. The retractable seat cover system of claim 1, wherein the leading edge of the seat cover includes attachment features for releasably attaching the seat cover to the headrest posts.

4. The retractable seat cover system of claim 3, wherein the attachment features are selected from the group consisting of a hook and a U-shaped snap fastener.

5. The retractable seat cover system of claim 1, wherein the anchor clipping attachment is a one-piece attachment having a base and a pair of opposed jaws extending therefrom.

6. The retractable seat cover system of claim 1, wherein the anchor clipping attachment is a one-piece attachment having a base and a hook extending therefrom.

7. The retractable seat cover system of claim 1, wherein the anchor clipping attachment includes a magnet for magnetic attachment to the fixed anchor of the seat.

8. A retractable seat cover system for attachment to fixed anchors on a seat, the seat including headrest posts, the retractable cover system comprising:
a seat cover movable from a rolled initial position to a deployed position, the seat cover having a having a leading edge, a base edge, a first side edge and a second side edge opposite the first side edge, the seat cover having a long axis;
an elongated attachment sleeve component slidably attached to the seat cover, the sleeve component extending between the first side edge and the second side edge of the seat cover, the sleeve component being movably positioned perpendicular to the long axis of the cover, the sleeve component having a cover-the sleeve component being movable between the leading edge and the base edge of the cover; and
a plurality of anchor clipping attachments movably fitted to the elongated attachment sleeve component.

9. The retractable seat cover system of claim 8, wherein the elongated attachment sleeve component includes a first end and a second and wherein the anchor clipping attachments are movable between the first and second ends.

10. A retractable seat cover system comprising:
a housing including a base and a lid that are joined together at a hinge, the base and lid defining a cavity within the housing when the housing is in a closed position, the base and lid configured to move relative to one another about the hinge to an opened position at the housing;
a first mounting cap and a second mounting cap that are configured to be fixed to a vehicle seat, the first mounting cap configured to releasably receive and secure a first end of the housing and the second mounting cap configured to releasably receive and secure a second end of the housing;
a cover configured to be placed in the cavity of the housing, the cover having a first end with a first anchor attached thereto that is configured to be outside of the housing when the housing is in the closed position, a second end configured to be retained within the housing when the housing is in the closed position, and a second anchor disposed on the cover at a position between the first end and the second end of the cover; and
an anchor clip configured to be secured between a seat back and a seat bottom of the vehicle seat and to selectively receive and retain the second anchor of the cover.

11. The retractable seat cover system of claim 10 wherein the first mounting cap and second mounting cap are configured to be fixed to a frame of the vehicle seat and wherein the first mounting cap and the second mounting cap are configured to be fixed under a seat bottom of the vehicle seat.

12. The retractable seat cover system of claim 10 wherein at least one of the first mounting cap and the second mounting cap includes a spring rolling mechanism configured to retract the cover into the housing.

13. The retractable seat cover system of claim 10 wherein the cover has a third anchor fixed to the second end of the cover, the third anchor configured to retain the second end of the cover within housing when the housing is in the closed position.

14. The retractable seat cover system of claim 10 wherein the first anchor is configured to selectively secure the first end of the cover to a top of a seat back of the vehicle seat and wherein the first end of the cover additionally includes a handle attached thereto for pulling the cover from the housing.

15. The retractable seat cover system of claim 10 wherein the first anchor is configured to selectively secure the first end of the cover to a headrest of the vehicle seat.

16. The retractable seat cover system of claim 10 wherein the first anchor is a hook or a clip.

17. The retractable seat cover system of claim 10 wherein the first anchor is a pocket sewn into the cover that is configured to be fitted over a seat back of the vehicle seat.

18. The retractable seat cover system of claim 10 wherein the cover is configured to be entirely removed from the housing.

19. The retractable seat cover system of claim 10 wherein the cover includes a plurality of cutouts near the second anchor through which vehicle seat hardware is accessible.

20. The retractable seat cover system of claim 10 wherein the anchor clip has a U-shaped cross section.
